(19) United States
(12) Patent Application Publication
(10) Pub. No.: US 2013/0147981 A1
(43) Pub. Date: Jun. 13, 2013

(54) SYSTEM AND METHOD FOR ADJUSTING BRIGHTNESS OF A DISPLAY SCREEN OF AN ELECTRONIC DEVICE

(71) Applicant: CONG WU, Shenzhen City (CN)

(72) Inventor: CONG WU, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/528,847

(22) Filed: Jun. 21, 2012

(30) Foreign Application Priority Data
Dec. 12, 2011 (CN) 201110411569.3

(51) Int. Cl. H04N 5/225

(52) U.S. Cl. 348/222.1; 348/E05.024

(57) ABSTRACT

In a method for adjusting brightness of a display of an electronic device, the method sets a plurality of brightness levels of the display screen, and sets a plurality of brightness intervals of brightness values of images captured by a camera device of the electronic device, each brightness interval corresponding to a range of the brightness values. The method further controls the camera device to capture an image of an ambient scene of the electronic device at each predetermined time interval. A brightness value of the captured image is calculated, and a brightness interval of the calculated brightness value is determined. The method adjusts the brightness of the display screen to a brightness level corresponding to the determined brightness interval of the calculated brightness value.

### BACKGROUND

1. Technical Field

Embodiments of the present disclosure relate to brightness adjustment technology, and more particularly to a system and method for adjusting the brightness of a display screen of an electronic device.

2. Description of Related Art

Brightness of a display screen of an electronic device may be manually adjusted according to habits of a user or an environment of the electronic device. However, manual adjustments of the brightness of the display screen are inconvenient and inefficient. Therefore, some electronic devices use light sensing elements (e.g. light sensors) to sense the brightness of ambient light of the electronic device, and adjust the brightness of the display screen automatically according to the ambient light. However, the automatic adjustments of the brightness of the display screen need to add at least one light sensing element in the electronic device, which may increase cost of the display screen.

### BRIEF DESCRIPTION OF THE DRAWINGS

FIG. 1 is a block diagram of one embodiment of an electronic device including a brightness adjustment system.

FIG. 2 is a schematic diagram of one embodiment of brightness levels and corresponding brightness intervals of brightness values.

FIG. 3 is a flowchart of one embodiment of a method for adjusting brightness of a display of the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module” as used herein refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media include compact discs (CDs), digital versatile discs (DVDs), Blu-ray disks, flash memory, and hard disk drives.

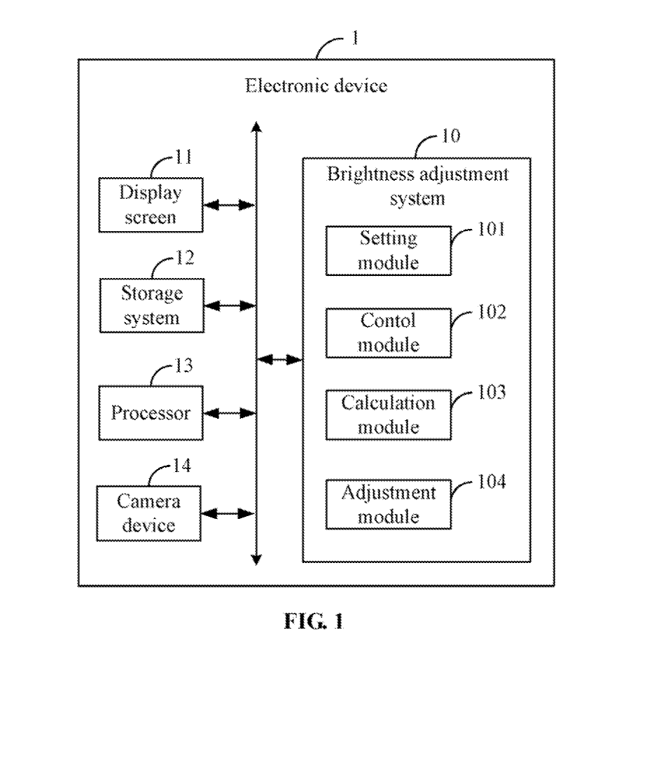

FIG. 1 is a block diagram of one embodiment of an electronic device 1 including a brightness adjustment system 10. The electronic device 1 further includes a display screen 11, a storage system 12, at least one processor 13, and a camera device 14. The display screen 11 displays visible data of the electronic device 1. The camera device 14 may capture images of an ambient scene of the electronic device 1. In one embodiment, the camera device 14 may be a front camera or a rear camera of the electronic device 1. The brightness adjustment system 10 may adjust brightness of the display screen 11 automatically according to brightness values of the images captured by the camera device 14.

The storage system 12 stores data of the electronic device 1. The storage system 12 may be a memory of the electronic device 1, or an external storage card, such as a smart media card, or a secure digital card. The at least one processor 13 executes one or more computerized codes and other applications of the electronic device 1, to provide functions of the brightness adjustment system 10. In one embodiment, the electronic device 1 may be a mobile phone, a notebook computer, a personal digital assistant (PDA), a mobile Internet device (MID), or any other electronic devices with the display screens and the camera devices.

In the embodiment, the brightness adjustment system 10 may include a setting module 101, a control module 102, a calculation module 103, and an adjustment module 104. The modules 101-104 comprise computerized codes in the form of one or more programs that are stored in the storage system 12. The computerized codes include instructions that are executed by the at least one processor 13 to provide functions for the modules. Details of each of the modules 101-104 will be given.

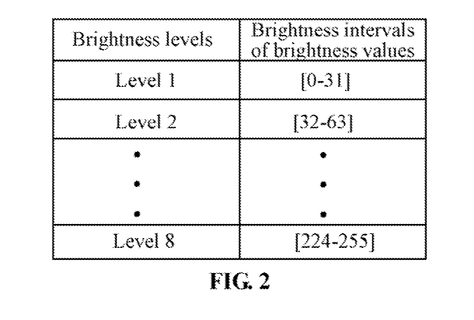

The setting module 101 sets a plurality of brightness levels of the display screen 11, and sets a plurality of brightness intervals of brightness values of images captured by the camera device 14. Each brightness level corresponds to a range of the brightness values. FIG. 2 is a schematic diagram of one embodiment of the brightness levels and corresponding brightness intervals of brightness values. In one embodiment, the setting module 101 sets eight brightness levels including brightness level 1 to brightness level 8 as shown in FIG. 2. The range of the brightness values of the images is from 0 to 255. As shown in FIG. 2, according to the eight brightness levels, the setting module 101 sets eight brightness intervals including [0-31], [32-65], . . . , and [224-255] of the brightness values. The brightness interval of [0-31] corresponds to the brightness level 1, the brightness interval of [32-65] corresponds to the brightness level 2, for example.

The control module 102 controls the camera device 14 to capture an image of an ambient scene of the electronic device 1 at each predetermined time interval. The predetermined time interval may be 5 seconds, or 5 minutes, and the predetermined time interval can be set according to user preference.

The calculation module 103 calculates a brightness value of the captured image, and determines a brightness interval of the calculated brightness value. In one embodiment, the brightness value of the each pixel of the captured image is calculated according to a luminance component “Y” in a YUV color model of the captured image. The luminance component “Y” in the color space of “YUV” represents the brightness of the captured image, two chrominance components “UV” represent colors of the captured image. The luminance component “Y” is calculated according to a formula of “Y=0.299R+0.587G+0.114B” according to RGB values of the captured image. In one embodiment, the calculation module 103 calculates the brightness value of each pixel of the captured image, and obtains the brightness value of the captured image by calculating an average brightness value according to the brightness value of each pixel of the captured image.

The adjustment module 104 adjusts the brightness of the display screen 11 to a brightness level corresponding to the determined brightness interval of the calculated brightness value. For example, if the calculated brightness value of the captured image is 55, the brightness interval of the calculated brightness value is determined to [32-65], and the brightness interval of [32-65] corresponds to the brightness level 2. The adjustment module 104 adjusts the brightness of the display screen 11 to brightness level 2.

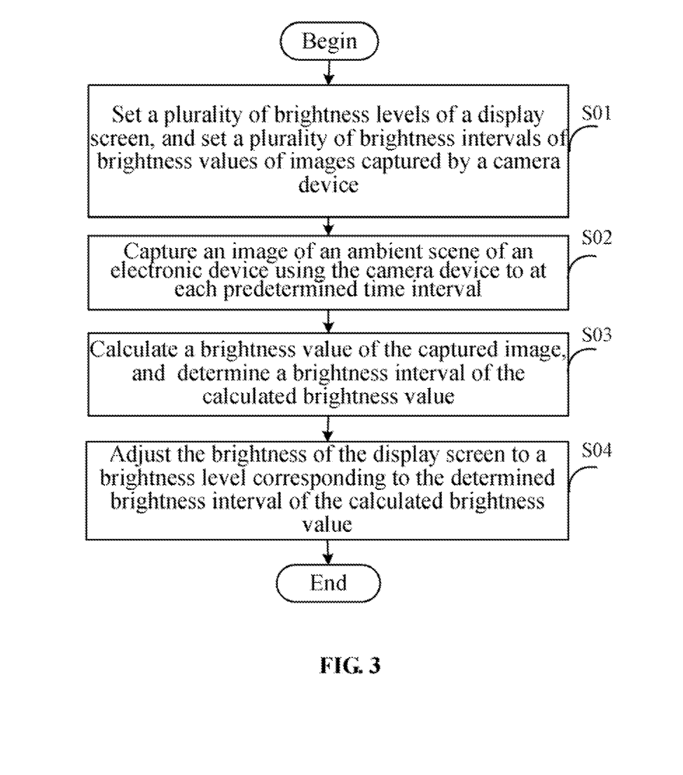

FIG. 3 is a flowchart of one embodiment of a method for adjusting brightness of the display screen 11 of the electronic device of FIG. 1. Depending on the embodiment, additional steps may be added, others deleted, and the ordering of the steps may be changed.

In step S01, the setting module 101 sets a plurality of brightness levels of the display screen 11, and sets a plurality of brightness intervals of brightness values of images captured by the camera device 14. Each brightness level corresponds to a range of brightness values. The range of the brightness values of the images is from 0 to 255.

In step S02, the control module 102 controls the camera device 14 to capture an image of an ambient scene of the electronic device 1 at each predetermined time interval. The predetermined time intervals may be 5 seconds, or 5 minutes, and can be set according to user preference.

In step S03, the calculation module 103 calculates a brightness value of the captured image, and determines a brightness interval of the calculated brightness value. In one embodiment, the brightness value of the captured image is calculated according to a luminance component “Y” in a color space of “YUV.” The luminance component “Y” can be calculated according to a formula of “Y=0.299R+0.587G+0.114B” according to the RGB color model. The calculation module 103 calculates the brightness value of each pixel of the captured image, and obtains the brightness value of the captured image by calculating an average brightness value according to the brightness value of each pixel of the captured image.

In step SO4, the adjustment module 104 adjusts the brightness of the display screen 11 to a brightness level corresponding to the determined brightness interval of the calculated brightness value.

All of the processes described above may be embodied in, and be fully automated via functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method of a display screen of an electronic device, the electronic device comprising a camera device, the method comprising:
setting a plurality of brightness levels of the display screen, and setting a plurality of brightness intervals of images captured by the camera device, each brightness level of the display screen corresponding to a range of the brightness values;
capturing an image of an ambient scene of the electronic device using the camera device at each predetermined time interval;
calculating a brightness value of the captured image, and determining a brightness interval of the calculated brightness value;
adjusting the brightness of the display screen to a brightness level corresponding to the determined brightness interval of the calculated brightness value.

2. The method according to claim 1, wherein the step of calculating a brightness value of the captured image comprises:
calculating a brightness value of each pixel of the captured image;
obtaining the brightness value of the captured image by calculating an average brightness value according to the brightness value of each pixel of the captured image.

3. The method according to claim 2, wherein the brightness value of the each pixel of the captured image is calculated according to a luminance component “Y” of each pixel in a YUV color model of the captured image, and the luminance component “Y” is calculated according to a formula of “Y=0.299R+0.587G+0.114B” according to RGB values of the each pixel in the captured image.

4. The method according to claim 1, wherein the camera device is a front camera or a rear camera of the electronic device.

5. The method according to claim 1, wherein the electronic device is a mobile phone, a notebook computer, a personal digital assistant (PDA), or a mobile Internet device (MID).

6. A non-transitory storage medium storing a set of instructions, when executed by at least one processor of an electronic device, cause the at least one processor to perform a method of a display screen of an electronic device, the electronic device comprising a camera device, the method comprising:
setting a plurality of brightness levels of the display screen, and setting a plurality of brightness intervals of brightness values of images captured by the camera device, each brightness level of the display screen corresponding to a range of the brightness values;
capturing an image of an ambient scene of the electronic device using the camera device at each predetermined time interval;
calculating a brightness value of the captured image, and determining a brightness interval of the calculated brightness value;
adjusting the brightness of the display screen to a brightness level corresponding to the determined brightness interval of the calculated brightness value.

7. The non-transitory storage medium according to claim 6, wherein the step of calculating a brightness value of the captured image comprises:
calculating a brightness value of each pixel of the captured image;
obtaining the brightness value of the captured image by calculating an average brightness value according to the brightness value of each pixel of the captured image.

8. The non-transitory storage medium according to claim 7, wherein the brightness value of the each pixel of the captured image is calculated according to a luminance component “Y” of each pixel in a YUV color model of the captured image, and the luminance component “Y” is calculated according to a formula of “Y=0.299R+0.587G+0.114B” according to RGB values of the each pixel in the captured image.

9. The non-transitory storage medium according to claim 6, wherein the camera device is a front camera or a rear camera of the electronic device.

10. The non-transitory storage medium according to claim 6, wherein the electronic device is a mobile phone, a notebook computer, a personal digital assistant (PDA), or a mobile Internet device (MID).

11. An electronic device, comprising:
a display screen;
a camera device;
a storage system;
at least one processor; and
one or more programs that are stored in the storage system and executed by the at least one processor, the one or more programs comprising:
a setting module that sets a plurality of brightness levels of the display screen, and sets a plurality of brightness intervals of brightness values of images captured by the camera device, each brightness level of the display screen corresponding to a range of the brightness values;
a control module that controls the camera device to capture an image of an ambient scene of the electronic device at each predetermined time interval;
a calculation module that calculates a brightness value of the captured image, and determines a brightness interval of the calculated brightness value;
an adjustment module that adjusts the brightness of the display screen to a brightness level corresponding to the determined brightness interval of the calculated brightness value.

12. The electronic device according to claim 11, wherein the calculation module calculates the brightness value of the captured image by:
calculating a brightness value of each pixel of the captured image;
obtaining the brightness value of the captured image by calculating an average brightness value according to the brightness value of each pixel of the captured image.

13. The electronic device according to claim 12, wherein the brightness value of the each pixel of the captured image is calculated according to a luminance component “Y” of each pixel in a YUV color model of the captured image, and the luminance component “Y” is calculated according to a formula of “Y=0.299R+0.587G+0.114B” according to RGB values of the each pixel in the captured image.

14. The electronic device according to claim 11, wherein the camera device is a front camera or a rear camera of the electronic device.

15. The electronic device according to claim 11, wherein the electronic device is a mobile phone, a notebook computer, a personal digital assistant (PDA), or a mobile Internet device (MID).
